(19) United States
(12) Patent Application Publication
(10) Pub. No.: US 2008/0222119 A1
(43) Pub. Date: Sep. 11, 2008

(54) Detecting a user's location, local intent and travel intent from search queries

(75) Inventors: Honghua (Kathy) Dai, Redmond, WA (US); Ying Li, Bellevue, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/715,794

(22) Filed: Mar. 8, 2007

(51) Int. Cl. G06F 17/30

(52) U.S. Cl. 707/4; 707/E17.018

(57) ABSTRACT

A search query history for a user is analyzed to determine a home location of the user. Subsequent search queries are analyzed to discern whether the search query contains local intent, meaning that the search query requests information having an area of geographic relevance. In cases where a search query has local intent, the area of geographic relevance for that search query is compared to the home location of the user to determine whether the search query suggests an intent to travel.

### BACKGROUND

The Internet has achieved such widespread use that many individuals use it to research products and services, and to purchase those products and services. Such use is so prevalent that a very large number of businesses conduct substantial commerce over the Internet. Economic use of the Internet has birthed countless new mechanisms for attempting to monetize Internet traffic and online attention. One such mechanism that has apparently proven its viability is online advertising.

Today, online advertising is an accepted practice engaged in by many businesses, especially large businesses. One reason for the success of online advertising is the ability to tailor particular ads to individual users in ways totally unthinkable with conventional advertising. However, the computing industry endlessly strives to continue improving the way ads can be tailored to individuals.

In a similar vein, online searching is perhaps one of the most frequent uses of the Internet. However, at the current stage of development, users are equally surprised both at how good the quality of results to certain search queries and at how bad the quality of results can be to other search queries. In particular, search queries that pertain to a particular geographic location can sometimes return results tailored to that location, but sometimes not. Development in the area of discerning geographic location information from user search requests and using that geographic location information, such as in advertising, remains in its infancy.

An adequate solution to this problem has eluded those skilled in the art, until now.

### SUMMARY

The invention is directed generally at detecting location-related information from search queries. In one embodiment, search query history for a user is analyzed to determine a home location of the user. Subsequent search queries are analyzed to discern whether the search query contains local intent, meaning that the search query requests information having an area of geographic relevance. In cases where a search query has local intent, the area of geographic relevance for that search query is compared to the home location of the user to determine whether the search query suggests an intent to travel.

### BRIEF DESCRIPTION OF THE DRAWINGS

Many of the attendant advantages of the invention will become more readily appreciated as the same becomes better understood with reference to the following detailed description, when taken in conjunction with the accompanying drawings, briefly described here.

FIG. 1 is a graphical illustration of a computing environment in which embodiments of the invention may be implemented.

FIG. 2 is a graphical representation of an execution environment including functional components that may be implemented in the computing environment introduced in conjunction with FIG. 1, in accordance with one embodiment.

FIG. 3 is a functional block diagram of an exemplary computing device that may be used to implement one or more embodiments of the invention.

FIG. 4 is an operational flow diagram generally illustrating a process for detecting travel intent from a user's search queries.

FIG. 5 is an operational flow diagram generally illustrating a process for identifying a user's home location from the user's search history.

FIG. 6 is an operational flow diagram generally illustrating a process for detecting a local intent from a search query.

Embodiments of the invention will now be described in detail with reference to these Figures in which like numerals refer to like elements throughout.

### DETAILED DESCRIPTION OF THE DRAWINGS

Various embodiments are described more fully below with reference to the accompanying drawings, which form a part hereof, and which show specific exemplary implementations for practicing various embodiments. However, other embodiments may be implemented in many different forms and should not be construed as limited to the embodiments set forth herein; rather, these embodiments are provided so that this disclosure will satisfy formal statutory requirements. Embodiments may be practiced as methods, systems or devices. Accordingly, embodiments may take the form of a hardware implementation, an entirely software implementation, or an implementation combining software and hardware aspects. The following detailed description is, therefore, not to be taken in a limiting sense.

The logical operations of the various embodiments are implemented (1) as a sequence of computer implemented steps running on a computing system and/or (2) as interconnected machine modules within the computing system. The implementation is a matter of choice dependent on various considerations, such as performance requirements of the computing system implementing the embodiment. Accordingly, the logical operations making up the embodiments described herein may be referred to alternatively as operations, steps or modules.

Illustrative Systems

The principles and concepts will first be described with reference to a sample system that implements certain embodiments of the invention. This sample system may be implemented using conventional or special purpose computing equipment programmed in accordance with the teachings of this disclosure.

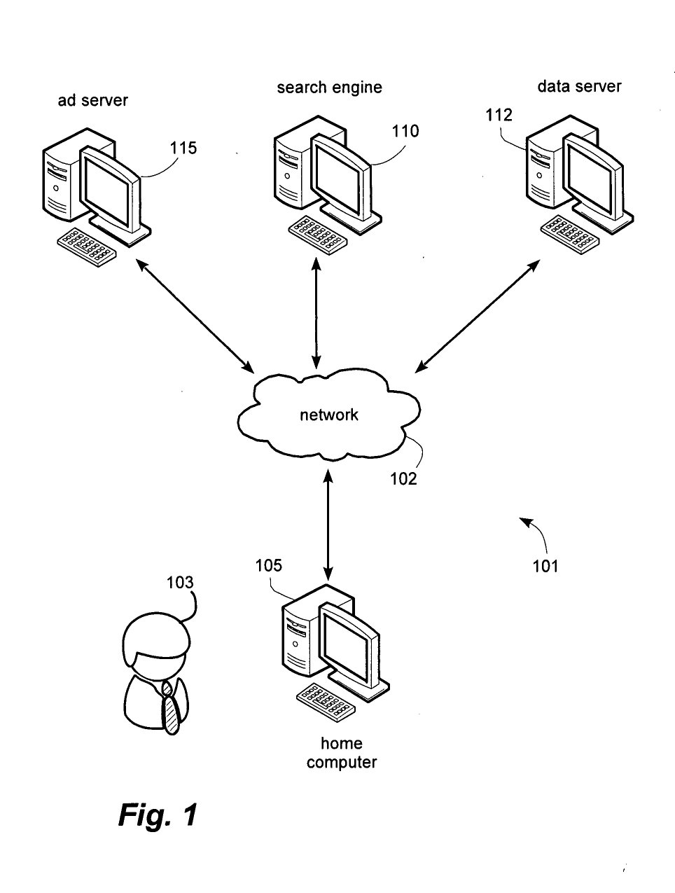

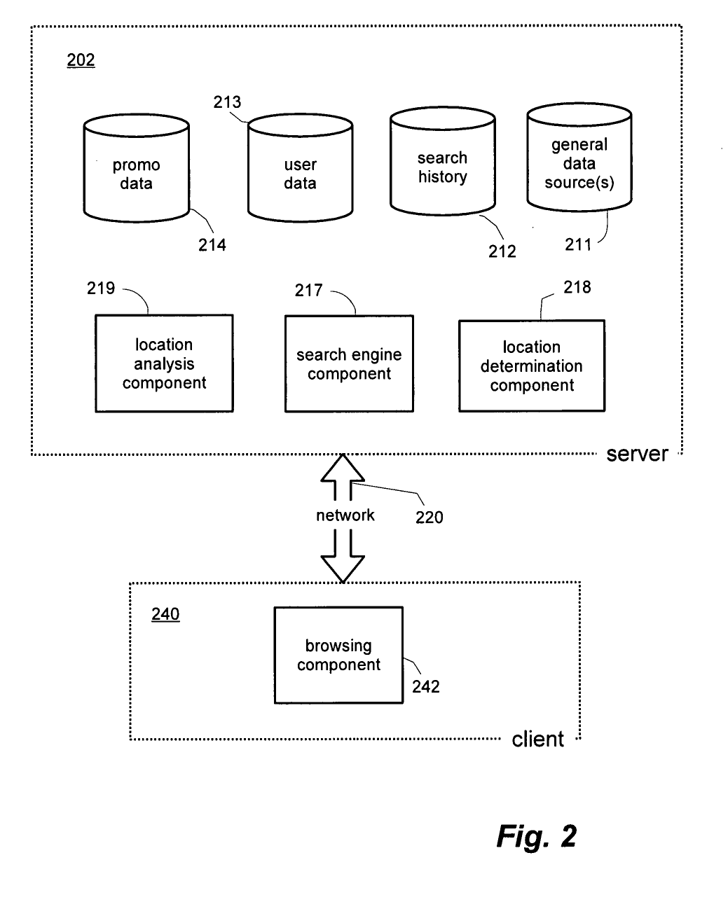

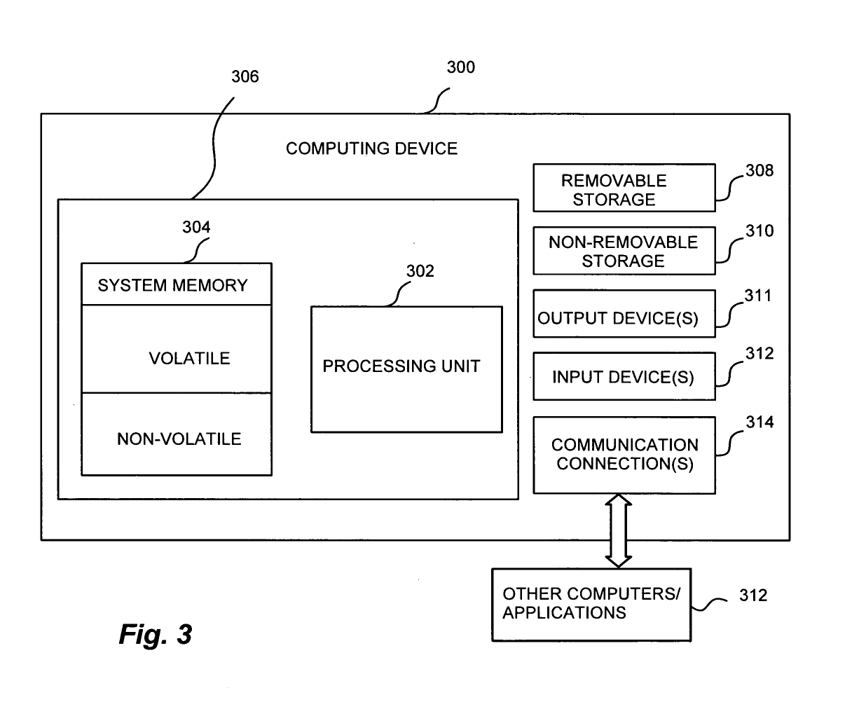

FIG. 1 is a graphical illustration of a computing environment 101 in which embodiments of the invention may be implemented. The computing environment 100 may be implemented using any conventional computing devices, such as the computing device illustrated in FIG. 3 and described below, configured in accordance with the teachings of this disclosure. Specific functionality that may be distributed over one or more of the computing devices illustrated in FIG. 1 will be described in detail in conjunction with FIGS. 2-5. However, as an overview, the general operations performed by one embodiment will be described here in conjunction with FIG. 1.

The computing environment 100 includes at least a search engine 110 and a home computer 105 connected over a network 102. The network 102 can be any electrical components and supporting software for interconnecting two or more disparate computing devices. Examples of the network 102 include a local area network, a wide area network, a metro area network, the Internet, and the like.

In this implementation, the home computer 105 represents a computing device, such as the computing device illustrated in FIG. 3, that an entity (user 103) uses relatively frequently to conduct research or information searching. Although illustrated as a human being, it should be noted that the user 103 could be any form of entity or agent capable of performing computer searches or information retrieval.

The search engine 110 is a computing device, such as the computing device illustrated in FIG. 3, that offers information searching services. In one example, the search engine 110 enables other computing devices, such as the home computer 105, to search various data sources for information related to a topic. Typically, the home computer 105 presents a search query to the search engine 110, and the search engine 110 returns search results related to the search query. The search results are commonly links to data sources, such as Web pages, usually, but not necessarily, resident on another computing device (data server 112).

An ad server 115 may also be included in the computing environment 101. The ad server 115 may operate in conjunction with the search engine 110 to serve advertisements or other promotional material in conjunction with search results to the user's search requests. Typically, the ads being served can be somewhat tailored to the interests of the user 103 because the search engine 110 stores history information about the user's searches. In one simple example, if the user 103 frequently performs searches for information about muscle cars, the search engine 110 may be configured to retrieve ads from the ad server 115 related to performance automobiles.

In addition, and in accordance with this embodiment, the search engine 110 is configured to identify a dominant query location for searches performed by the user 103 using the home computer 105. As used in this discussion, the “dominant query location” refers to a geographic area or location to which or about which a particular search query pertains. For example, if the user 103 performs a search for “Seattle restaurants,” the search engine 110 may determine that the search pertains to the city of Seattle. Accordingly, the dominant query location for this search would be Seattle. All search queries do not necessarily have a dominant query location, but many do.

The search engine 110 is further configured to identify a “home location” for the home computer 105. For the purpose of this discussion, the “home location” refers to a geographic location that is identified as where the user 103 lives or resides, works, or otherwise spends a considerable amount of time. The home location is identified based on an analysis of a history of searches performed by the user 103, perhaps using the home computer 105. The analysis includes identifying a dominant query location for a significant number of searches in the user's search history, and identifying one location that appears with a greater frequency or greater degree of relevance than other locations. That one location is considered to be the user's home location.

It should be noted that the “home location” could either be associated with the home computer 105 or with the actual user 103 depending on how the search history is accumulated and categorized. For example, if the search engine 110 requires a login so that the user 103 can be personally identified, then the search history and home location can be assigned to the user 103 directly regardless of which computer the user 103 uses. Alternatively, the search engine 110 may be able to collect other information, such as usage cookies or Internet Protocol (IP) addresses, for each computer that performs searches. In this way, the search engine 110 may associate a search history and home location with the home computer 105, which may have multiple users. However, for simplicity of discussion only, the home location will be described as being associated with the user 103, but it has equal applicability in cases where the home location is actually associated with a computer instead.

The search engine 110 is still further configured to determine an intention by the user 103 to travel based on searches performed by the user 103. As mentioned above, the search engine 110 is configured to identify a dominant query location from each search performed by the user 103. The search engine 110 is also configured to identify the user's home location. Thus, once the user's home location is identified, each subsequent search request by the user 103 that has a dominant query location can be compared to the user's home location. In those cases where a search has a “local intent,” meaning that the search pertains to a particular geographic area, and a dominant query location that differs from the user's home location, an intent by the user to travel to the dominant query location of the search may be assumed (a “travel intent”).

Although this assumption may and likely will prove false in some instances, it is still helpful in many ways. For example, if the user 103 is performing a search for a restaurant in San Francisco, that information alone would not have been sufficient to assume that the user 103 intended to travel to San Francisco, unless one believed that the user 103 lived on Bainbridge Island. Accordingly, the advances enabled by this embodiment allow the search engine 110 to better identify appropriate advertisements from the ad server 115 to present to the user 103 in conjunction with the search results. In other words, if the user 103 was searching for restaurants in San Francisco, it would be meaningless to display an ad for travel related services if the user 103 lived in San Francisco, but it might be very appropriate if the user 103 did not live in San Francisco.

Turning now to FIG. 2, a block diagram illustrates the distribution of functionality across certain components that implement one embodiment. Shown in FIG. 2 are a server 202 and a client 240 in communication over a network 220. The client 240 represents one or more computing devices under control of a user. The client 240 is available to a user to perform searches by issuing search requests over the network 220 to the server 202. The client 240 includes at least a browsing component 242, which may be any software or computing functionality that enables the client 240 to connect to the server 202 and interact with components on the server 202. The browsing component 242 may support functionality to help uniquely identify the client 240, such as Internet cookies or other proprietary functionality for providing user/computer identification information.

The server 202 is illustrated as a single component for simplicity of discussion only. It should be appreciated that the functional components illustrated in FIG. 2 within a single server 202 could easily be distributed over two or more physical computing devices. Moreover, the functionality described within each singular component illustrated in FIG. 2 could easily be implemented as two or more actual software modules, applications, or components. Similarly, the functionality described within any two or more of the singular components illustrated in FIG. 2 could be combined into a single actual software module or application.

Various disparate sources of data that are accessible by the server 202 are represented as a single data store (general data sources 211) in FIG. 2. The general data sources 211 component exemplifies various and sundry sources of information that are accessible over the network 220, such as newspaper Web sites, Internet blogs, commercial Web sites, personal informational sites, universities and other schools, wikis, and the like. Generally stated, general data sources 211 could be any source of data that is searchable using conventional search engine technology.

The server 202 includes user data 213 which represents information stored about individual users of the server 202. As mentioned above, the term “user” does not necessarily refer to a human being, but rather refers to any unique entity (human or otherwise) that the server 202 treats as a collective unit for purposes of analysis. The user data 213 may include various forms of information, such as a name or user ID, login credentials, and other information about each particular user, including the user of the client 240. One particular item of information that may be stored in association with each user in the user data 213 is a home location for the corresponding user. As discussed above, the home location represents a geographic area determined to likely be the user's home geographic location (e.g., home city, state, and country) or other primary geographic area of interest (e.g., corporate headquarters if the user is a business entity).

The search history 212 represents a collection of information about previous searches posed to the server 202 by various users. The search history 212 is organized in association with various users, and may include information that corresponds a particular search history with a particular user in the user data 213. For many searches in the search history for a user, a dominant query location may be included that identifies a geographic area determined to be pertinent to the search. The mechanism for determining the dominant query location is the location determination component 218, described below. However, all searches do not necessarily have a dominant query location. Each search may have an associated attribute, such as a boolean flag or the like, to indicate whether the search pertains to a dominant query location.

A promo data store 214 may be included in the server 202 to contain various forms of promotional information, such as advertisements, newsletters, or other information. Some of the promotional information may also have a geographic area of interest, meaning that certain promotional material may only be important within a relatively-small geographic area, such as a city or even a neighborhood. For example, an advertisement for a local pizza parlor may not have meaning outside of the city in which the pizza parlor exists.

A location determination component 218 is incorporated in the server 202 and is operative to identify a dominant query location for a particular search request. As discussed above, a dominant query location is a geographic area (e.g., a city, state, or even country) to which a search request pertains. Techniques for identifying a dominant query location for search requests are known in the art, and any appropriate technique may be employed by the location determination component 218. One good technique is described in detail in U.S. Patent Publication Number 20060085392, published on Apr. 20, 2006, and titled “System and Method for Automatic Generation of Search Results Based on Local Intention,” although other techniques may be equally applicable. Briefly stated, these techniques analyze words both in the search request itself as well as words and phrases within the most relevant search results to discern the dominant query location. The location determination component 218 evaluates new search requests for dominant query locations and may store those locations in association with the search requests or with the search results, such as in the search history 212.

The location determination component 218 is further configured to identify a “local intent” from a search query. As mentioned above, the term “local intent” refers to a suggestion that a search query pertains to information having some degree of locality or geographic significance. In other words, a search for “Albert Einstein biography” is likely not driven by any desire to learn about a particular geographic location. However, “Albert Einstein birthplace” may be driven by such a desire. Accordingly, even though there is no geographic location identified by the search query, the results are likely to be focused on a particular geographic area. In addition, search terms such as “starbucks,” “landscaping services,” and “plumbing contractors,” may not suggest a particular geographic area. However, it is likely that the user desires information about those things in a certain location, such as near the user's home. These search terms are deemed to have “local intent.”

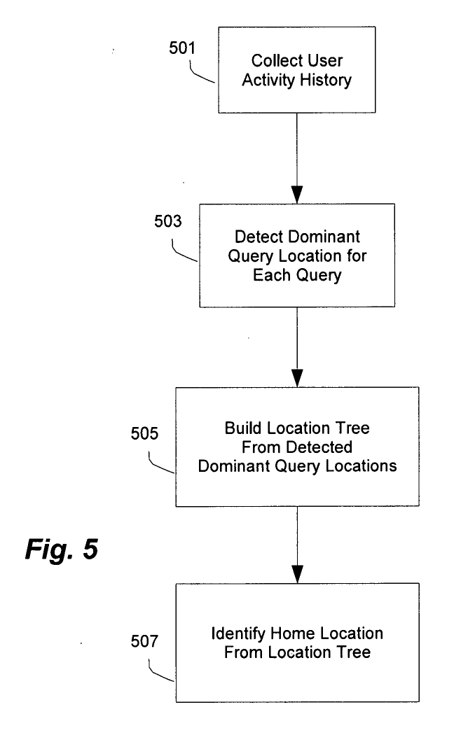

A location analysis component 219 is operative to analyze a user's search history to identify a home location. Many different techniques may be employed by the location analysis component 219, including statistical analysis, evaluations based on empirical data, and the like. One specific technique for identifying the home location that may be employed by the location analysis component 219 is illustrated in FIG. 5 and described below. Generally stated, the location analysis component 219 operates on the principle that the typical computer user performs more searches having a dominant query location related to the user's actual home geographic location than any other individual location.

The search engine component 217 is configured to perform conventional search engine operations, as well as facilitate the detection of a travel intent from the user's search habits. More specifically, the search engine component 217 interacts with the client 240 to receive search requests and to search the general data sources 211 for search results. The search engine component 217 stores search requests in the search history 212, and may request that each search be analyzed by the location determination component 218 to identify a local intent and/or a dominant query location. When an adequate search history has been compiled for a user, the search engine component 217 requests the location analysis component 219 to analyze the search history 212 to identify a home location for the user. The search engine component 217 invokes the location determination component 218 to identify a local intent and/or a dominant query location for each subsequent search request. For each search having local intent, the search engine component 217 compares its dominant query location (if any) to the user's home location. In cases where the dominant query location of a search request differs from the user's home location, the search engine component 217 may conclude that the user has travel intent. In those cases, the search engine component 217 may use that information to help influence which promotions 214 to present to the user during that search session.

While described here generally, additional details about certain operations performed during such a scenario are provided below in conjunction with illustrative processes that may be used to implement embodiments. However, first a sample computing device that may be used to implement these embodiments will be described.

FIG. 3 is a functional block diagram of an exemplary computing device 300 that may be used to implement one or more embodiments of the invention. The computing device 300, in one basic configuration, includes at least a processor 302 and memory 304. Depending on the exact configuration and type of computing device, memory 304 may be volatile (such as RAM), non-volatile (such as ROM, flash memory, etc.) or some combination of the two. This basic configuration is illustrated in FIG. 3 by dashed line 306.

Additionally, device 300 may also have other features and functionality. For example, device 300 may also include additional storage (removable and/or non-removable) including, but not limited to, magnetic or optical disks or tape. Such additional storage is illustrated in FIG. 3 by removable storage 308 and non-removable storage 310. Computer storage media includes volatile and nonvolatile, removable and non-removable media implemented in any method or technology for storage of information such as computer readable instructions, data structures, program modules or other data. Memory 304, removable storage 308 and non-removable storage 310 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 300. Any such computer storage media may be part of device 300.

Computing device 300 includes one or more communication connections 314 that allow computing device 300 to communicate with one or more computers and/or applications 313. Device 300 may also have input device(s) 312 such as a keyboard, mouse, digitizer or other touch-input device, voice input device, etc. Output device(s) 311 such as a monitor, speakers, printer, PDA, mobile phone, and other types of digital display devices may also be included. These devices are well known in the art and need not be discussed at length here.

Illustrative Processes

The principles and concepts will now be described with reference to sample processes that may be implemented by a computing device, such as the computing device illustrated in FIG. 3, in certain embodiments. The processes may be implemented using computer-executable instructions in software or firmware, but may also be implemented in other ways, such as with programmable logic, electronic circuitry, or the like. In some alternative embodiments, certain of the operations may even be performed with limited human intervention. Moreover, the processes are not to be interpreted as exclusive of other embodiments, but rather are provided as illustrative only.

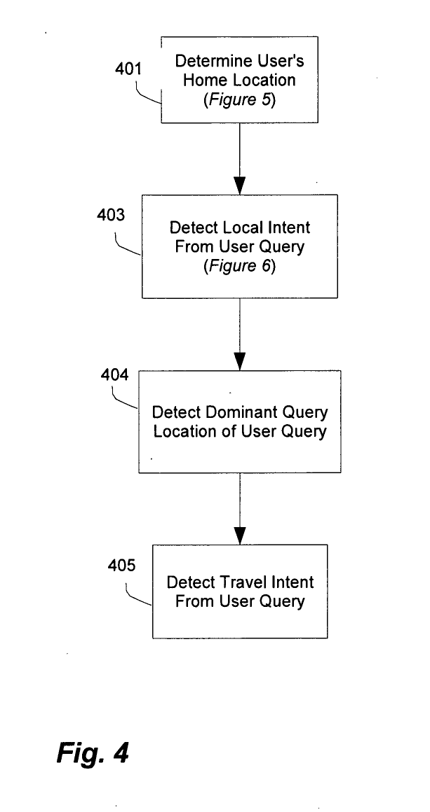

FIG. 4 is an operational flow diagram generally illustrating a process for detecting travel intent from a user's search queries. The process may be implemented in various computing environments using various computing devices, such as those described above and illustrated in FIGS. 1-3.

The process begins at block 401, where a user's home location is determined. Operations that may be performed at this step are described in detail in conjunction with FIG. 5. Briefly stated, a user's search history is evaluated to identify a geographic area of most relevant interest to the user (the user's “home location”).

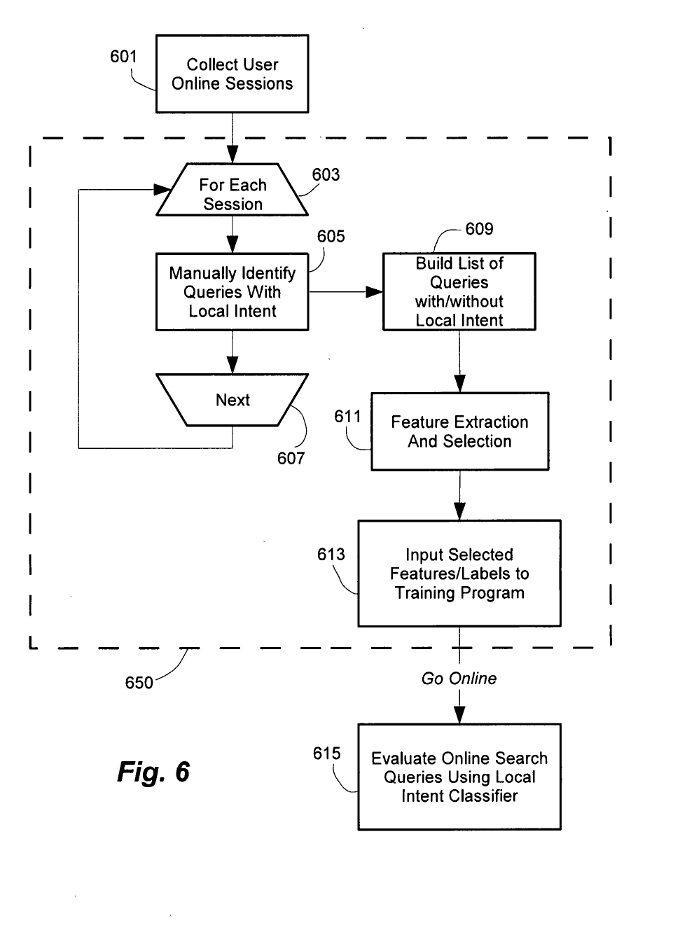

At block 403, subsequent search queries are evaluated for local intent. The local intent may be a score or a boolean value that indicates whether the search query likely pertains to a particular geographic area. Operations that may be performed at this step are described in detail below in conjunction with FIG. 6.

At block 404, a dominant query location for subsequent search queries is investigated. As described above, the dominant query location may be a geographic area suggested or invoked by a particular search query. For example, the search query “Manhattan hotels” suggests the geographic area of New York City. In addition, the search queries “white house” and “lincoln memorial” suggest the Washington, D.C. area even though no specific location is identified in the search terms.

At block 405, a user's travel intent is detected for a particular search query for which a local intent and a dominant query location have been determined. The travel intent may be identified by comparing the dominant query location of a search query having local intent to the user's home location. In cases where the two differ, a travel intent can be inferred. Identifying the user's travel intent provides additional information that may be used to tailor promotions or advertisements that may be presented to the user.

FIG. 5 is an operational flow diagram generally illustrating a process for identifying a user's home location from the user's search history. At block 501, the user's search activity is collected and stored as a search history. The search history may span several search sessions with few or very many searches performed during each session. The search history includes at least the search terms in the search query, and may include the results of the search.

At block 503, a dominant query location is identified for as many search queries in the search history as is reasonably possible. The dominant query location is identified as described above, and is stored in conjunction with its corresponding search query.

At block 505, in accordance with this implementation, a location tree is constructed with the dominant query locations identified at block 503. The location tree contains nodes of locations at different geographic levels (country, province, and cities). Each node has 2 properties: frequency and entropy. In this implementation, the root of the location tree is “The Earth,” the next level is “countries,” the third level is “state/provinces,” and a fourth level is “cities/towns.”

The tree initially contains only the root node. Every location detected at block 503 is added to the location tree in the following manner:
Increment the root node's frequency by 1.
If the country of the location is already in the tree, increment the frequency of the country node by 1; otherwise append the country node with frequency=1.
If the state/province of the location is already in the tree, increment the frequency of the state/province node by 1; otherwise append the state/province node with frequency=1.
If the city of the location is already in the tree, increment the frequency of the city node by 1; otherwise append the city node with frequency=1.

An entropy is computed for each node in the location tree using the following example formula:

$$Entropy Node = - {\sum }_{i = 1}^{n} ( \frac{fi}{{\sum }_{j = 1}^{n} fj} \times LOG ( \frac{fi}{{\sum }_{j = 1}^{n} fj} ) )$$

where a node has “n” distinct children nodes with frequency: f1, f2, . . . , fn.

At block 507, after the location tree is built, a home location is determined from the location tree. One specific technique among many for determining the home location is presented here. If the root node's frequency is less than some frequency threshold, return “no location detected.” If the root node's Entropy is greater than or equal to some entropy threshold, return “no location detected.” Otherwise, pick the country node with maximal frequency.

If the country node's frequency is less than some frequency threshold, return “no location detected.” Otherwise set this country name as the detected country of the user.

If the computed Entropy of the country node is greater than or equal to some entropy threshold, return the detected country as the location of the user. Otherwise pick the state/province child node with maximal frequency.

If the state/province node's frequency is less than some frequency threshold, return the detected country as the user's location. Otherwise set this state/province name as the detected state/province of the user.

If the computed Entropy of the state/province node is greater than or equal to some entropy threshold, return the detected state/province plus the detected country as the location of the user. Otherwise pick the city/town child node with maximal frequency.

If the city/town node's frequency is less than some frequency threshold, return the detected state/province plus the detected country as the location of the user. Otherwise set this city/town, the previously detected state/province, and the detected country as the home location of the user.

FIG. 6 is an operational flow diagram generally illustrating a process for detecting local intent for a search query. In this particular implementation, detecting local intent occurs in two stages. An offline “training stage” is performed to construct a local intent classifier, which is a tool that can be used to evaluate whether an online search query evidences local intent. For the purpose of clarity, the operations that may be performed during the offline stage are illustrated in FIG. 6 within dashed-line box 650.

At block 601, a user's online search sessions are collected for offline evaluation. This operation may be performed by a computing device that offers information searching services over a network, such as a search engine. Search engines routinely distinguish between various users that perform searches using the search engine service, and often maintain search history information about each of those users or perhaps groups of users. In such an implementation, a search engine may collect information about each search performed by a user, and may aggregate individual searches by session, where the term “session” refers to an interval in which a user was continuously active with the search engine. Any activities (e.g., search queries, search results, clicks, etc.) should be committed, perhaps within some threshold.

Block 603 begins an iterative loop where the search queries in each session stored at step 601 are evaluated (block 605) to determine if the search queries suggest a local intent. In this particular implementation, this operation may be performed in an automated fashion but may also be performed by human beings. The evaluation includes examining each search query and perhaps search terms within the search query to determine if a local intent is involved. For example, a search query such as “Malay Satay Hut menu” may be a strong indication that the user intends to visit that restaurant or some place nearby. In that case, local intent may be ascribed to the search query. In contrast, a search query such as “research paper published in university of Washington CS department” suggests that the user is searching for information to download online rather than to visit the University of Washington, which would not evidence local intent.

Some queries might be ambiguous regarding local intent. For example, “seattle mariner games” might be searched both by users interested in going to a game and those who just want to know the scores. In such a case, the user's home location (if known) or other user activity may be used to disambiguate the intent. For instance, if the user searched “mariner tickets” and the user's home location was determined to be near Seattle, a more confident local intent conclusion could be reached. The process iterates (block 607) over all the online sessions.

At block 605, each search query for a session is labeled as either “true” for suggesting local intent, or “false” for not suggesting local intent. A list of search queries and their associated labels is constructed (block 609) for each session evaluated.

At block 611, a feature extraction and selection method is applied to the lists of search queries and labels constructed at block 609. This method is performed to identify features in each search query or search results that suggest a local intent. For example, the method may extract entity names, terms, or other content from the search results for each query. The selected features and the labels are input to a training program, such as a Support Vector Machine (SVM) or Logistic Regression (LR) program (block 613). The training program statistically analyzes the various labels, search queries, terms, and other input to categorize and quantify the “local intent” for each of those inputs. The output from the training program becomes a “local intent classifier,” which is a program for on-the-fly evaluation of new search queries for local intent.

At block 615, the online portion of local intent detection is performed. The online portion of the local intent determination occurs while a user is connected to a search engine and performing searches. These operations may be performed in parallel with collecting more online sessions and information for a user (e.g., block 601, block 501). It should be appreciated that the online local intent detection improves with additional training and data collection. In short, during an online session, a search engine provides each new search query to the local intent classifier to determine if local intent is present or suggested. If so, a flag is set to indicate that the search query suggests local intent. The user's home location (if known) may also be used with the local intent classifier.

With the search query evaluated for local intent, operation may return to the process illustrated in FIG. 4, and described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method for detecting a user's travel intent, the method comprising:
detecting a user's home location from a search history associated with the user, at least a plurality of individual search requests in the search history each having an associated dominant query location;
detecting a local intent from a subsequent search request issued by the user, the local intent including a search dominant query location associated with the search request, the search dominant query location comprising a geographic area of relevance to the search request; and
comparing the search dominant query location to the home location to identify an intent to travel to the search dominant query location.

2. The method recited in claim 1, wherein the home location comprises a predominant dominant query location for the search history.

3. The method recited in claim 1, wherein identifying the home location comprises creating a location tree with each node comprising a search query in the search history.

4. The method recited in claim 3, wherein identifying the home location further comprises computing a frequency for each search query and an entropy for each search query.

5. The method recited in claim 1, wherein the home location comprises a country component, a state/province component, and a city/town component.

6. The method recited in claim 1, wherein detecting the local intent further comprises evaluating the subsequent search query to identify terms in the search query that indicate a geographic area of relevance to the subsequent search query.

7. The method recited in claim 6, wherein detecting the local intent further comprises human intervention to evaluate the terms in the search query.

8. The method recited in claim 1, further comprising selecting an advertisement for presentation to the user based on the travel intent.

9. The method recited in claim 1, wherein identifying the intent to travel comprises detecting that the local intent associated with the subsequent search query is a different geographic area than the home location.

10. A computer-readable medium encoded with computer-executable instructions for detecting a user's travel intent, the instructions comprising:
accumulating the user's search history, the search history comprising a plurality of search queries;
evaluating the search history to identify a home location for the user, the home location corresponding to a prevalent dominant query location for at least one search query in the search history;
receiving a subsequent search request from the user;
detecting a local intent from the subsequent search request;
detecting a search location for the subsequent search request, the search location being a geographic area of relevance to the subsequent search request; and
comparing the search location to the home location to identify an intent to travel to the dominant query location, the intent to travel comprising an indication that the home location differs from the search location.

11. The computer-readable medium recited in claim 10, wherein identifying the home location comprises creating a location tree with each node comprising a search query in the search history.

12. The computer-readable medium recited in claim 11, wherein identifying the home location further comprises computing a frequency for each search query and an entropy for each search query.

13. The computer-readable medium recited in claim 12, wherein the home location comprises a country component, a state/province component, and a city/town component.

14. The computer-readable medium recited in claim 10, wherein detecting the local intent further comprises evaluating the subsequent search query to identify terms in the search query that indicate a geographic area of relevance to the subsequent search query.

15. The computer-readable medium recited in claim 10, wherein detecting the local intent further comprises human intervention to evaluate the terms in the search query.

16. The computer-readable medium recited in claim 10, further comprising selecting an advertisement for presentation to the user based on the travel intent.

17. A computer-readable medium encoded with computer-executable components for identifying a user's travel intent, the components comprising:
a search engine component configured to collect search history for the user, the search history including a plurality of search queries, at least one of the search queries having a first dominant query location, the search engine component being further configured to return search results relevant to the search queries;
a location detection component configured to evaluate each of the search queries to identify any corresponding dominant query locations including the first dominant query location, the location detection component being further configured to evaluate subsequent search queries to identify a second dominant query location; and
a location analysis component configured to evaluate the plurality of search queries in the search history, including any dominant query locations identified by the location detection component, to identify a home location for the user, the home location corresponding to the first dominant query location if the first dominant query location represents a most prevalent dominant query location for the search history.

18. The computer-readable medium recited in claim 17, wherein the search engine component is further configured to compare the home location to the second dominant query location to determine if the second dominant query location differs from the home location, and if so, to indicate a travel intent.

19. The computer-readable medium recited in claim 18, wherein the search engine component is further configured to select an advertisement for presentation to the user based on the indication of the travel intent.

20. The computer-readable medium recited in claim 17, wherein the location detection component is further configured to perform a training operation wherein the location detection component involves human interaction to identify dominant query locations.
